(19) United States
(12) Patent Application Publication
(10) Pub. No.: US 2010/0038919 A1
(43) Pub. Date: Feb. 18, 2010

(54) PC tray latch

(76) Inventor: Kevin Wang, City of Industry, CA (US)

Correspondence Address: LAW OFFICES OF CLEMENT CHENG, 17220 NEWHOPE STREET #127, FOUNTAIN VALLEY, CA, 92708, US

(21) Appl. No.: 12/228,332

(22) Filed: Aug. 12, 2008

(51) Int. Cl. E05C 19/06

(52) U.S. Cl. 292/85

(57) ABSTRACT

A drive tray has a drive tray body with a retaining protrusion. A first lever arm is pivotally mounted on the drive tray body at a first lever arm first end and at a primary axis. The first lever arm has an open position and a closed position. The first lever arm also has a stopping protrusion. The first lever arm has a first lever arm length sufficient for providing a mechanical advantage to the stopping protrusion. The stopping protrusion protrudes away from a flat side of the drive tray for locking the drive tray to a case when in the first lever arm is in a closed position. The stopping protrusion retracts into a flat face of the drive tray when the first lever arm is in open position.

### BRIEF DISCUSSION OF RELATED ART

Personal computers have a wide variety of components such as hard drives, disk drives and peripherals mounted on a case. The case structure is generally in a tower configuration which is a rectangular box having a height greater than a width. The height of the box makes for the tower nomenclature. For all of these components, traditionally the components were attached to the tower by screw connection. For example, a CD-ROM drive typically has two pairs of two screws each for a total of four screws. The four screws are oriented with two screws on each side of a left and right side of the CD-ROM drive. Additionally, the CD-ROM drive would have the screw holes oriented to rails on the case for receiving the CD-ROM drive. While somewhat secure, the traditional configuration would require a power screwdriver and take some time for implementation. Later, improvements in the drive attachment made removal faster and easier. Unfortunately, some of those improvements did not make the drive very secure. Therefore, what is desired is a secure connection while still being easily removable.

### SUMMARY OF THE INVENTION

The drive tray preferred means of assembly involves assembling the drive tray latch first, and then attaching the drive tray latch to the drive tray. The drive tray latch body attaches to the drive tray via drive tray latch body screws passing through mounting holes in the drive tray latch body so as to connect to the drive tray. The drive tray latch body has a flat back meeting with the flat drive tray.

A first lever arm has a smooth bore axis bolt for attaching the first lever arm to the primary axis. The smoothbore axis bolt use security in place via a set screw having a broad head. The smoothbore axis bolt is shown in the figure as a flat head. The smoothbore axis bolt also has a broad head of preferably the same diameter as the head of the set screw. Those set screw can also be a flat head. The drive tray latch body forms a stepped depression for receiving the pair of broad heads in flush configuration to the exterior surface of the drive tray latch body.

The first lever arm has a stopper protrusion near the primary axis at a first end. The stopper protrusion preferably fits behind a lip of the case opening or otherwise engages with the side of the case so that the drive tray is secured to the side of the case via the stopper protrusion.

The first lever arm is connected to a second lever arm at a second end which is coextensive with a pin providing a pivot at a secondary axis. The second lever arm has a triangular tip hook engaging with a protrusion on drive tray latch body. A spring biases the hook against a hollow portion behind the protrusion on the drive tray latch body. The spring is mounted on a post on the second lever arm. The second lever arm is preferably formed with a finger hollow facing away from the user allowing the user to hook a finger into the second lever arm to rotate the second lever arm against spring bias for disengaging the triangular tip hook from the protrusion.

Some functional and optional features may be added to improve the present invention. Preferably, the spring is hidden in a notch formed on the first lever arm. Preferably, the first lever arm is made of anodized aluminum. Preferably, a grip surface is formed on the outside portion of the first lever arm in a location coinciding with a user thumb. Optionally, vertical holes can be drilled through the first lever arm.

The second lever arm may be made as a plastic injection molded piece. The first lever arm preferably has an arch shaped, or arc shaped which bends away from the drive tray initially, then bends toward the drive tray. The arc shape preferably terminates at the first lever arm second end providing a pointer finger groove on the inside surface of the first lever arm. When formed as a plastic member, the secondary axis pin passes through the top of the second lever arm, then passes through the first lever arm, and finally passes through the bottom of the second lever arm. The second lever arm sandwiches the first lever arm at the secondary axis pin.

### BRIEF DESCRIPTION OF THE DRAWINGS

FIG. 1 is an exploded view of the drive tray latch.

FIG. 2 is a top view of the drive tray latch.

FIG. 3 is a front view of the drive tray latch.

### DETAILED DESCRIPTION OF THE PREFERRED EMBODIMENT

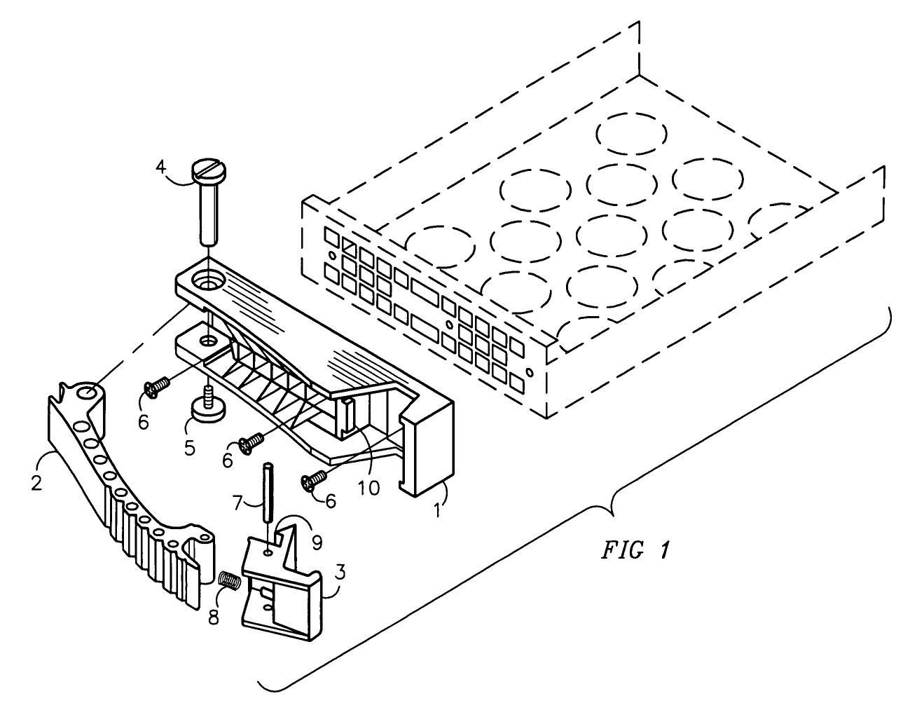

FIG. 1 shows a drive tray in dotted line and a drive tray latch mounted on a face of the drive tray. The drive tray as shown in the dotted line to signify that the preferred means of assembly involves assembling the drive tray latch first, and then attaching the drive tray latch to the drive tray. The drive tray latch body 1 attaches to the drive tray via drive tray latch body screws 6 passing through mounting holes in the drive tray latch body so as to connect to the drive tray. The drive tray latch body 1 has a flat back meeting with the flat drive tray.

A first lever arm 2 has a smooth bore axis bolt 4 for attaching the first lever arm 2 to the primary axis. The smoothbore axis bolt 4 use security in place via a set screw 5 having a broad head. The smoothbore axis bolt 4 is shown in the figure as a flat head. The smoothbore axis bolt 4 also has a broad head of preferably the same diameter as the head of the set screw 5. The smoothbore axis bolt has a smooth exterior. Those set screw 5 can also be a flat head. The drive tray latch body 1 forms a stepped depression for receiving the pair of broad heads in flush configuration to the exterior surface of the drive tray latch body 1.

The first lever arm 2 has a stopper protrusion near the primary axis at a first end. The stopper protrusion preferably fits behind a lip of the case opening or otherwise engages with the side of the case so that the drive tray is secured to the side of the case via the stopper protrusion.

The first lever arm 2 is connected to a second lever arm 3 at a second end which is coextensive with a pin 7 providing a pivot at a secondary axis. The second lever arm 3 has a triangular tip hook 9 engaging with a protrusion 10 on drive tray latch body 1. A spring 8 biases the hook 9 against a hollow portion behind the protrusion 10 on the drive tray latch body. The spring 8 is mounted on a post on the second lever arm 3. The second lever arm is preferably formed with a finger hollow facing away from the user allowing the user to hook a finger into the second lever arm 3 to rotate the second lever arm 3 against spring bias for disengaging the triangular tip hook 9 from the protrusion 10.

Some functional and optional features may be added to improve the present invention. Preferably, the spring 8 is hidden in a notch formed on the first lever arm 2. Preferably, the first lever arm 2 is made of anodized aluminum. Preferably, a grip surface is formed on the outside portion of the first lever arm 2 in a location coinciding with a user thumb. Optionally, vertical holes can be drilled through the first lever arm 2. Preferably, the second lever arm 3 is stopped in rotation by a first lever arm rotation stopping protrusion on the first lever arm. The first lever arm rotation stopping protrusion is preferably made of anodized aluminum so that it also covers the spring 8. The stopping protrusion protrudes away from a flat face of the drive tray when elements are in closed position and the stopping protrusion retracts into the flat face of the drive tray when the elements are in open position.

The second lever arm may be made as a plastic injection molded piece. The first lever arm preferably has an arch shaped, or arc shaped which bends away from the drive tray initially, then bends toward the drive tray. The arc shape preferably terminates at the first lever arm second end providing a pointer finger groove on the inside surface of the first lever arm 2. When formed as a plastic member, the secondary axis pin 7 passes through the top of the second lever arm, then passes through the first lever arm, and finally passes through the bottom of the second lever arm. The second lever arm sandwiches the first lever arm at the secondary axis pin 7.

The first lever arm may additionally include a pusher protrusion in front of the stopper protrusion. The pusher protrusion can push against the case for dislodging the drive tray by overcoming static friction. The pusher protrusion pushes in the direction facing away from the user since it is on the opposite side of the user grip. The user grip is shown as a right-handed grip in all of the figures. The pusher protrusion and stopping protrusion are both operated at a mechanical advantage due to the length of the first lever arm. The first lever arm has a length sufficient for providing a mechanical advantage to the pusher protrusion and stopping protrusion.

The internal portion of the drive tray latch body may also include a number of through apertures formed in a grid pattern as shown in the figure. The grid pattern may match up with the grid pattern of the drive tray for enhanced airflow from the drive to the drive tray, to the external environment via the drive tray latch body. The drive tray latch body further includes a finger notch disposed vertically and allowing a finger to access the finger hollow of the second lever arm 3 when the first and second lever arms are in a closed position.

The user uses the device as follows. First, a user places the finger on the drive tray latch body 1 finger notch for accessing the finger hollow of the second lever arm 3. The user then puts a thumb on a grip surface of the first lever arm 2. The user pulls on the second lever arm 3 at the finger hollow portion which rotates the second lever arm 3 against the spring force of the spring 8 so that the second lever arm 3 is moved into open position where the triangular tip hook 9 of the second lever arm 3 is disengaged from the retaining protrusion 10 of the drive tray latch body 1. The user then rotates the first lever arm 2 into open position which disengages the stopper protrusion of the first lever arm which is near the first axis; and simultaneously, the user engages the pusher protrusion against the case for dislodging the drive tray from the case. The user then pulls on the first lever arm at the pointer finger groove on the inside surface of the first lever arm 2. The retaining protrusion 10 is shown on the right side of the drive tray latch body 1 opposite the primary axis on the left side.

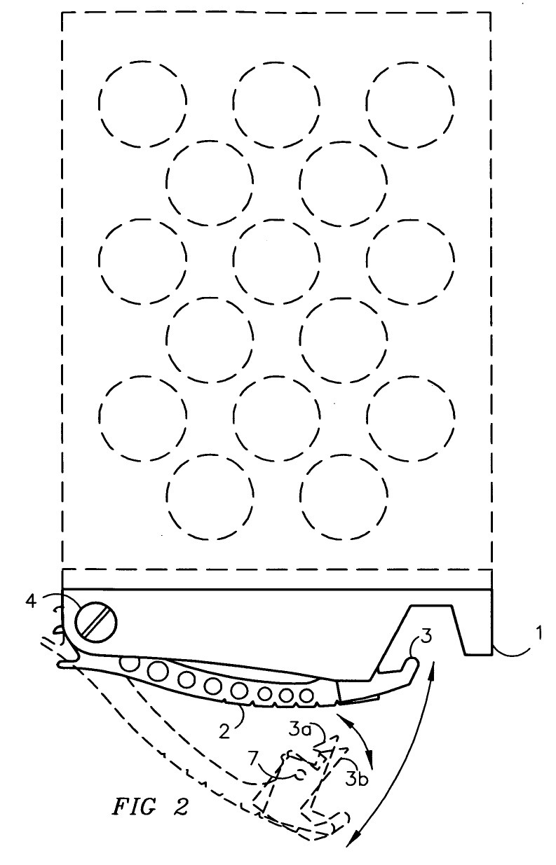

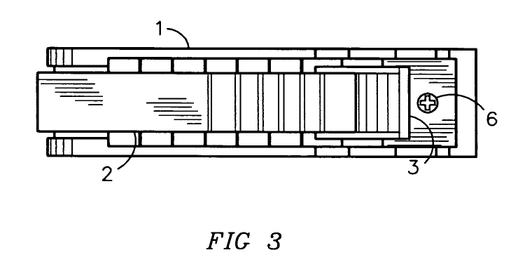

FIG. 2 shows a drive tray above having multiple circular openings for heat dissipation. The drive tray latch is shown below in both open and closed position. The solid line drawing shows the drive tray latch in closed position where the first lever arm 2 and the second lever arm 3 are both in closed position. The dotted line drawing of the first lever arm 2 and second lever arm 3 shows the first lever arm in open position with the second lever arm in an open position 3b and a closed position 3a. The mechanism for the primary axis 4 and mechanism for the secondary axis 7 are preferably arranged so that the primary axis and secondary axis are parallel. FIG. 3 is a front view of the drive tray showing that the first lever arm 2 has a first lever arm height which is less than a height of the second lever arm 3, which is less than a height of the drive tray latch body 1. FIG. 3 shows the right most of the three body screws 6 as a Philips screw screwing into a threaded portion of the drive tray. The middle body screw and the left body screw are hidden behind the first lever arm 2 in the view of FIG. 3. Thus, two of three body screws are hidden behind the first lever arm, when the first lever arm is in a first lever arm closed position

The present invention contemplates that many changes and modifications may be made. For example, the spring can be made as a single sheet of a flat leaf spring in a plane configuration. The spring could be formed as a rectangular strip of metal, or as a helical spring, or it could even be magnetic. Therefore, while the presently preferred forms of the improved device have been shown and described, and several modifications thereof discussed, persons skilled in this art will readily appreciate that various additional changes and modifications may be made without departing from the spirit of the invention, as defined and differentiated by the following claims.

1. A drive tray comprising:
a. a drive tray body having a retaining protrusion;
b. a first lever arm pivotally mounted on the drive tray body at a first lever arm first end and at a primary axis, wherein the first lever arm has an open position and a closed position, wherein the first lever arm further comprises a stopping protrusion, wherein the first lever arm has a first lever arm length sufficient for providing a mechanical advantage to the stopping protrusion, wherein the stopping protrusion protrudes away from a flat side of the drive tray for locking the drive tray to a case when in the first lever arm is in a closed position, wherein the stopping protrusion retracts into a flat face of the drive tray when the first lever arm is in open position;
c. a second lever arm pivotally mounted to a first lever arm at a first lever arm second end and at a secondary axis so that it has a second lever arm closed position and a second lever arm open position, wherein the second lever arm further comprises a hook which engages the retaining protrusion of the drive tray body when the second lever arm and the first lever arm are both in a closed position and
d. a spring mounted between the second lever arm and the first lever arm, biasing second lever arm towards a second lever arm closed position.

2. The drive tray of claim 1 further comprising: a grip surface is formed on an outside portion of the first lever arm in a location coinciding with a user thumb.

3. The drive tray of claim 1 further comprising: vertical holes through the first lever arm.

4. The drive tray of claim 1 further comprising: a finger notch on the drive tray latch body for accessing a finger hollow on the second lever arm.

5. The drive tray of claim 1 wherein the first lever arm has a first lever arm height which is less than a height of the second lever arm, which in turn is less than a height of the drive tray latch body.

6. The drive tray of claim 1 further comprising three body screws, namely: a left body screw securing the drive tray latch body to the drive tray; a middle body screw securing the drive tray latch body to the drive tray and a left body screw securing the drive tray latch body to the drive tray, wherein the two of three body screws are hidden behind the first lever arm, when the first lever arm is in a first lever arm closed position.

7. The drive tray of claim 1 further comprising: a pusher protrusion formed in front of the stopper protrusion on the first lever arm for dislodging the drive tray by pushing in a direction facing away from the user.

8. The drive tray of claim 7 further comprising: a grip surface is formed on an outside portion of the first lever arm in a location coinciding with a user thumb.

9. The drive tray of claim 7 further comprising: vertical holes through the first lever arm.

10. The drive tray of claim 7 wherein the first lever arm has a first lever arm height which is less than a height of the second lever arm, which in turn is less than a height of the drive tray latch body.

11. The drive tray of claim 7 further comprising three body screws, namely: a left body screw securing the drive tray latch body to the drive tray; a middle body screw securing the drive tray latch body to the drive tray and a left body screw securing the drive tray latch body to the drive tray, wherein the two of three body screws are hidden behind the first lever arm, when the first lever arm is in a first lever arm closed position.

12. The drive tray of claim 7 further comprising: a finger notch on the drive tray latch body for accessing a finger hollow on the second lever arm.

13. The drive tray of claim 12 further comprising: a grip surface is formed on an outside portion of the first lever arm in a location coinciding with a user thumb.

14. The drive tray of claim 12 further comprising: vertical holes through the first lever arm.

15. The drive tray of claim 12 wherein the first lever arm has a first lever arm height which is less than a height of the second lever arm, which in turn is less than a height of the drive tray latch body.

16. The drive tray of claim 12 further comprising three body screws, namely: a left body screw securing the drive tray latch body to the drive tray; a middle body screw securing the drive tray latch body to the drive tray and a left body screw securing the drive tray latch body to the drive tray, wherein the two of three body screws are hidden behind the first lever arm, when the first lever arm is in a first lever arm closed position.

17. The drive tray of claim 16 further comprising: a grip surface is formed on an outside portion of the first lever arm in a location coinciding with a user thumb.

18. The drive tray of claim 16 further comprising: vertical holes through the first lever arm.

19. The drive tray of claim 16 wherein the first lever arm has a first lever arm height which is less than a height of the second lever arm, which in turn is less than a height of the drive tray latch body.

20. The drive tray of claim 16 further comprising: a grip surface is formed on an outside portion of the first lever arm in a location coinciding with a user thumb; and vertical holes through the first lever arm; and wherein the first lever arm has a first lever arm height which is less than a height of the second lever arm, which in turn is less than a height of the drive tray latch body.
